(19) United States
(12) Patent Application Publication
(10) Pub. No.: US 2026/0091710 A1
(43) Pub. Date: Apr. 2, 2026

(54) FOREIGN SUBSTANCE BLOCKING DEVICE OF VEHICLE SEAT RAIL

(71) Applicant: HYUNDAI TRANSYS INC., Seosan-si (KR)

(72) Inventors: Cheon KIM, Hwaseong-si (KR); Seong Jun HWANG, Hwaseong-si (KR); Heoung Su LIM, Hwaseong-si (KR); Kyeong Ho SEO, Suwon-si (KR); Jung Hyun HAN, Hwaseong-si (KR)

(21) Appl. No.: 19/308,848

(22) Filed: Aug. 25, 2025

(30) Foreign Application Priority Data
Sep. 30, 2024 (KR) 10-2024-0132337

(51) Int. Cl. B60N 2/07; B60N 2/015

(52) U.S. Cl. CPC B60N 2/0727; B60N 2/015

(57) ABSTRACT

A foreign substance blocking device of a vehicle seat rail includes a lower rail formed to extend lengthwise along a floor panel of a vehicle, the lower rail being fixedly installed on the floor panel, an upper rail coupled to the lower rail and mounted on a seat cushion, the upper rail being configured to enable the seat cushion to be slidably movable along the lower rail, the upper rail being slidably movable toward a foremost position in a tilting walk-in mode, and a rail cover coupled to the lower rail and disposed to be in contact with an upper surface of the upper rail, the rail cover being configured to be rotatably moved in conjunction with sliding movement of the upper rail toward a foremost position in the tilting walk-in mode such that an open inner area of the lower rail is shielded by the rail cover.

### CROSS-REFERENCE TO RELATED APPLICATION

This application claims priority, under 35 U.S.C. § 119(a), to Korean Patent Application No. 10-2024-0132337, filed on Sep. 30, 2024, the entire contents of which are incorporated herein by reference.

### BACKGROUND

### (a) Technical Field

The present disclosure relates to a foreign substance blocking device of a vehicle seat rail, and more particularly, to a foreign substance blocking device of a vehicle seat rail capable of preventing foreign substances from entering the interior of a lower rail through an opening hole formed in the upper surface of the lower rail.

### (b) Background Art

In general, a vehicle seat includes a seatback and a seat cushion and is mounted on a seat sliding device configured to enable the seat cushion to be slidably moved in the forward-and-rearward direction of a vehicle body.

Normally, a front seat is mounted on a sliding device formed to have a short longitudinal length and configured to provide a short forward-and-rearward movement distance. Conversely, in the case of recreational vehicles (RVs) and vans having a larger vehicle body and a larger floor panel than those of passenger cars, a sliding device formed to have a long longitudinal length is installed therein to increase a degree of adjustment for a forward-and-rearward movement distance of a vehicle seat. Accordingly, sufficient leg room for a passenger may be secured, and a comfortable interior living space may be provided.

The above-described seat sliding devices may be classified into a manually-operated seat sliding device and an electrically-operated seat sliding device depending on the operating method, and the electrically-operated seat sliding device is widely used to increase user convenience.

Here, in a structural configuration of the electrically-operated seat sliding device, an upper rail fixedly installed on a vehicle seat is movable along a lower rail fixedly installed on the vehicle floor by a drive motor, a gear box (a reducer), and a lead screw, enabling the vehicle seat to be moved forwards and rearwards.

Meanwhile, as an example in which the electrically-operated seat sliding device is driven, tilting walk-in technology has recently been employed to allow a passenger sitting on the third-row seat to comfortably exit the vehicle. Through the tilting walk-in technology, a seat may be moved to the foremost position, and then a seat frame may be tilted forwards, thereby securing a maximum space for a passenger to enter or exit the vehicle.

However, in the tilting walk-in technology, when the second-row seat is moved forwards, a rail is exposed to the outside, and the exposed rail may cause various problems.

First, annoying noise is generated by various foreign substances entering the inside of the exposed rail.

For example, when a seat is moved to the foremost position in the tilting walk-in mode, a lead screw is exposed from a lower rail, and foreign substances such as sand, dust, and mud may be introduced into a gap between the lower rail and the lead screw. When such foreign substances are introduced into the gap, the foreign substances are also introduced into a gearbox. In this case, annoying noise and vibration may be generated due to backlash between gears, and customer satisfaction with the seat may deteriorate.

Second, foreign substances cause deterioration in durability of the gearbox and operation performance of an upper rail.

For example, when the seat is operated to move forwards or rearwards, foreign substances are introduced into the gearbox, leading to the adverse effect on operation performance and durability of the gearbox. If such problems continuously occur, marketability and quality of the seat may significantly deteriorate.

Third, when a passenger sitting on the third-row seat exits the vehicle, the passenger may be caught by the lower rail, causing a safety incident.

For example, when the second-row seat is moved to the foremost position through a tilting walk-in function so as to allow a passenger sitting on the third-row seat to exit the vehicle, a gap is generated due to the exposed lower rail, and a shoe heel of the passenger gets caught by or falls into the gap. Accordingly, there is a risk of accident.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an aspect of the present disclosure to provide a foreign substance blocking device of a vehicle seat rail, configured in such a manner that an upper rail is slidably moved along a lower area of a cover by the cover disposed upright on a lower rail, and when the upper rail is slidably moved to the foremost position of the lower rail according to a tilting walk-in operation, the cover is selectively rotated to come into close contact with the lower rail. In this manner, the foreign substance blocking device may shield an open upper surface of the lower rail using the cover and may prevent foreign substances from entering the interior of the lower rail.

In one aspect, the present disclosure provides a foreign substance blocking device for a vehicle seat rail, the foreign substance blocking device including a lower rail configured to extend lengthwise along a floor panel of a vehicle, the lower rail configured to be fixedly installed on the floor panel, the lower rail including an open inner area, an upper rail coupled to the lower rail and configured to be mounted on a seat cushion, the upper rail being configured to enable the seat cushion to be slidably movable along the lower rail, the upper rail being slidably movable toward a foremost position in a tilting walk-in mode, and a rail cover coupled to the lower rail and disposed to be in contact with an upper surface of the upper rail, the rail cover configured to be rotatably moved in conjunction with sliding movement of the upper rail toward the foremost position in the tilting walk-in mode such that an open inner area of the lower rail is shielded by the rail cover.

In a preferred embodiment, the rail cover may be disposed to be in close contact with an upper surface of the lower rail in the tilting walk-in mode and may be disposed to be in contact with the upper surface of the upper rail based with the tilting walk-in mode being released.

In another preferred embodiment, the rail cover may include a cover body disposed to contact the upper surface of the upper rail, the cover body being configured to extend lengthwise to selectively shield the open inner area, a connecting links rotatably connected to front and rear sides of one side of the cover body and rotatably coupled to the lower rail, the connecting links configured to guide rotational movement of the cover body, and a sliding movement guide coupled to a front side of the cover body, the sliding movement guide disposed to contact a rear surface of the upper rail based on the cover body selectively shielding the open inner area.

In still another preferred embodiment, the cover body may include a roller member mounted on a lower surface thereof, and the sliding movement of the upper rail may be performed by the roller member being in contact with the upper surface of the upper rail.

In yet another preferred embodiment, the upper rail may include a side wall member formed upright and to extend lengthwise to contact the other side of the cover body, the side wall member configured to guide a rotational movement path of the cover body.

In still yet another preferred embodiment, the cover body may have seating grooves formed therein, and the seating grooves may have shapes respectively corresponding to a shape of the lower rail and a shape of a lead screw mounted in the open inner area.

In a further preferred embodiment, the connecting link may include an elastic member, the elastic member configured to provide elastic force to the cover body in a direction in which the open inner area is shielded by the cover body.

In another further preferred embodiment, the sliding movement guide may include an elastic member, the elastic member configured to provide elastic force in a direction in which the sliding movement guide contacts the upper rail.

In still another further preferred embodiment, the sliding movement guide may be configured to form an inclination angle relative to the rear surface of the upper rail in the tilting walk-in mode.

In yet another further preferred embodiment, the sliding movement guide may include a stopper mounted in a connection area of the cover body, the stopper being configured to maintain the inclination angle based on the upper rail being slidably moved due to release of the tilting walk-in mode.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1A and FIG. 1B are views each showing a coupling position of a foreign substance blocking device of a vehicle seat rail according to an embodiment of the present disclosure;

FIG. 2 is a view showing a rail cover in the foreign substance blocking device of the vehicle seat rail according to the embodiment of the present disclosure;

FIG. 3 is a view showing rotational movement of the rail cover in the foreign substance blocking device of the vehicle seat rail according to the embodiment of the present disclosure;

FIG. 4A to FIG. 4C are views sequentially showing the operation of the rail cover according to a tilting walk-in mode in the foreign substance blocking device of the vehicle seat rail according to the embodiment of the present disclosure;

FIG. 5 and FIG. 6 are views each showing a shielded state of an open inner area in the foreign substance blocking device of the vehicle seat rail according to the embodiment of the present disclosure;

FIG. 7 is a view showing an elastic member in the foreign substance blocking device of the vehicle seat rail according to the embodiment of the present disclosure;

FIG. 8 is a view showing a stopper in the foreign substance blocking device of the vehicle seat rail according to the embodiment of the present disclosure;

FIG. 9 is a cross-sectional view of a seating groove in the foreign substance blocking device of the vehicle seat rail according to the embodiment of the present disclosure, taken along line A-A in FIG. 6; and

FIG. 10 is a view showing a roller member and a side wall member in the foreign substance blocking device of the vehicle seat rail according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, a preferred embodiment according to the present disclosure will be described in detail with reference to the accompanying drawings.

Advantages and features of the present disclosure and methods of achieving the same will become more apparent with reference to the embodiments described below in detail and the accompanying drawings.

However, the present disclosure is not limited by the embodiments disclosed below, and may be implemented in various forms. The embodiments are provided to make the present disclosure complete, and to fully inform those skilled in the art to which the present disclosure pertains of the scope of the disclosure, and the present disclosure is only defined by the scope of the claims.

In describing the embodiments disclosed herein, when it is determined that a detailed description of publicly known techniques to which the disclosure pertains may obscure the gist of the present disclosure, detailed description thereof will be omitted.

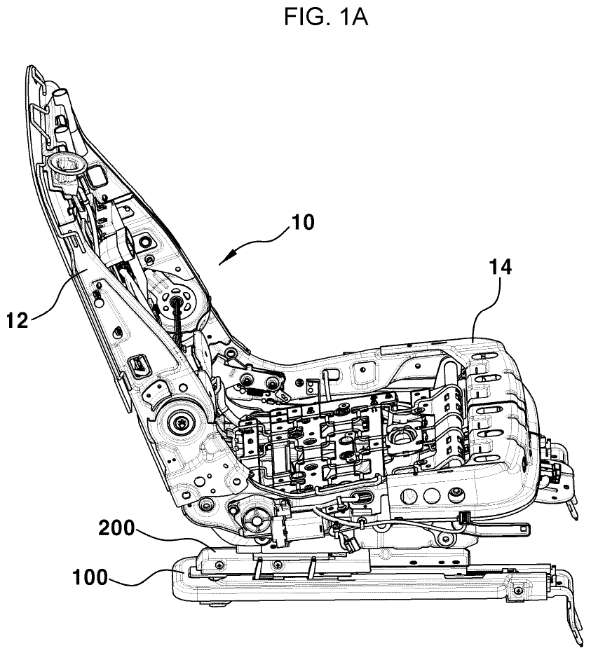

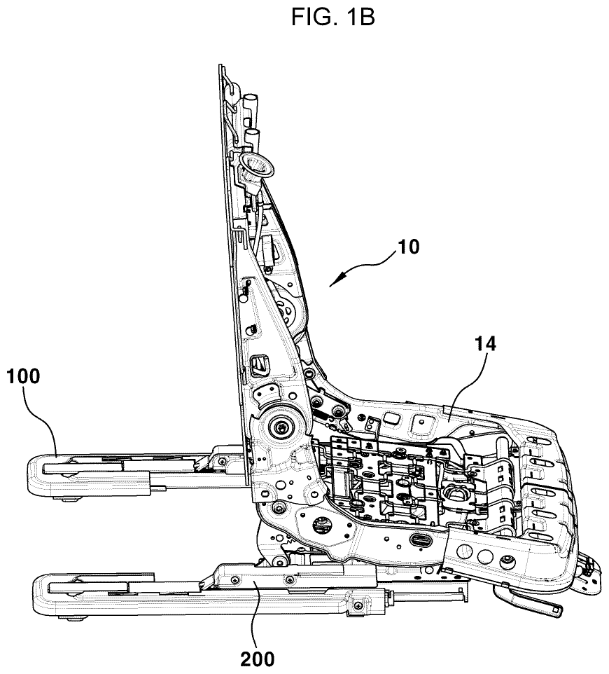

FIG. 1 is a view showing a coupling position of a foreign substance blocking device of a vehicle seat rail according to an embodiment of the present disclosure,

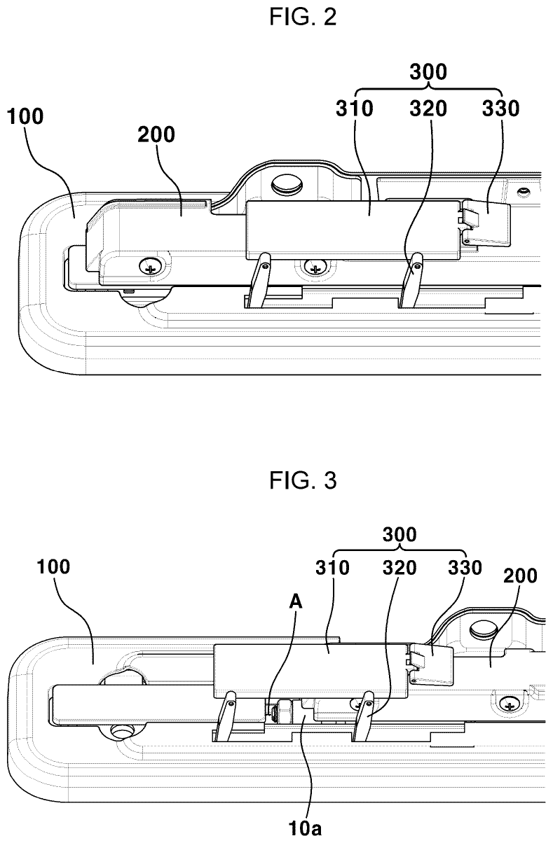

FIG. 2 is a view showing a rail cover in the foreign substance blocking device of the vehicle seat rail according to the embodiment of the present disclosure, and FIG. 3 is a view showing rotational movement of the rail cover in the foreign substance blocking device of the vehicle seat rail according to the embodiment of the present disclosure.

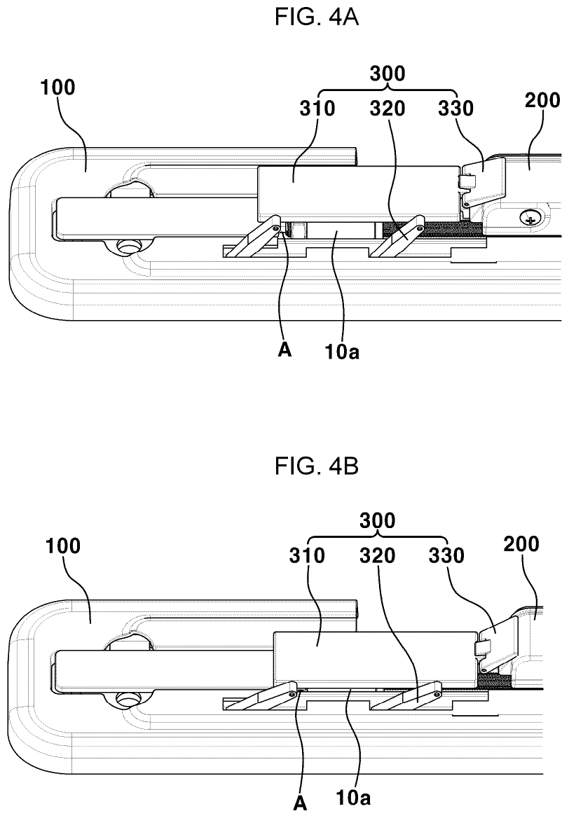

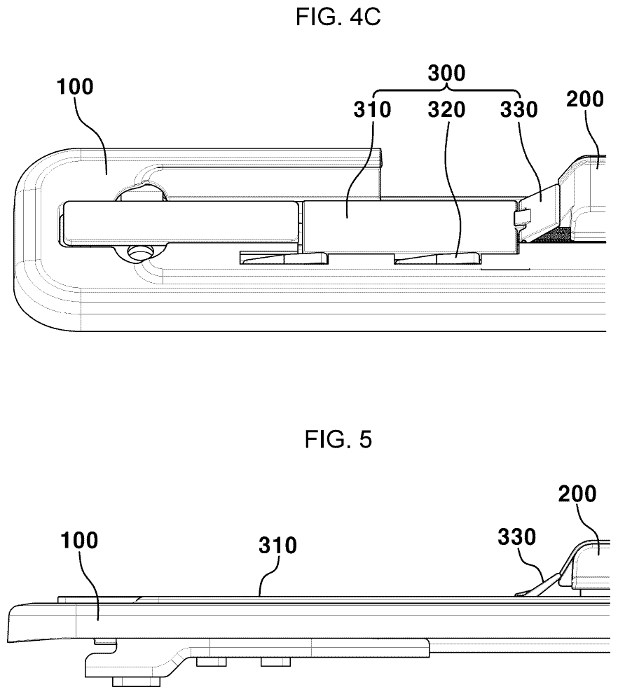

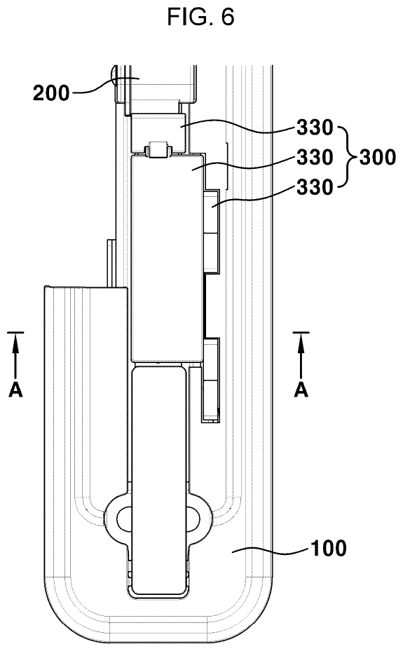

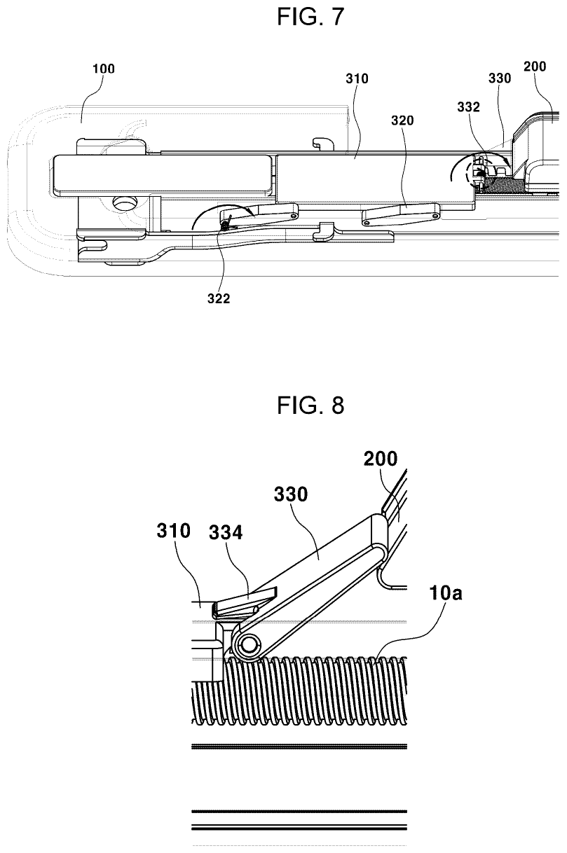

FIG. 4A to FIG. 4C are views sequentially showing the operation of the rail cover according to a tilting walk-in mode in the foreign substance blocking device of the vehicle seat rail according to the embodiment of the present disclosure, FIG. 5 and FIG. 6 are views each showing a shielded state of an open inner area in the foreign substance blocking device of the vehicle seat rail according to the embodiment of the present disclosure, and FIG. 7 is a view showing an elastic member in the foreign substance blocking device of the vehicle seat rail according to the embodiment of the present disclosure.

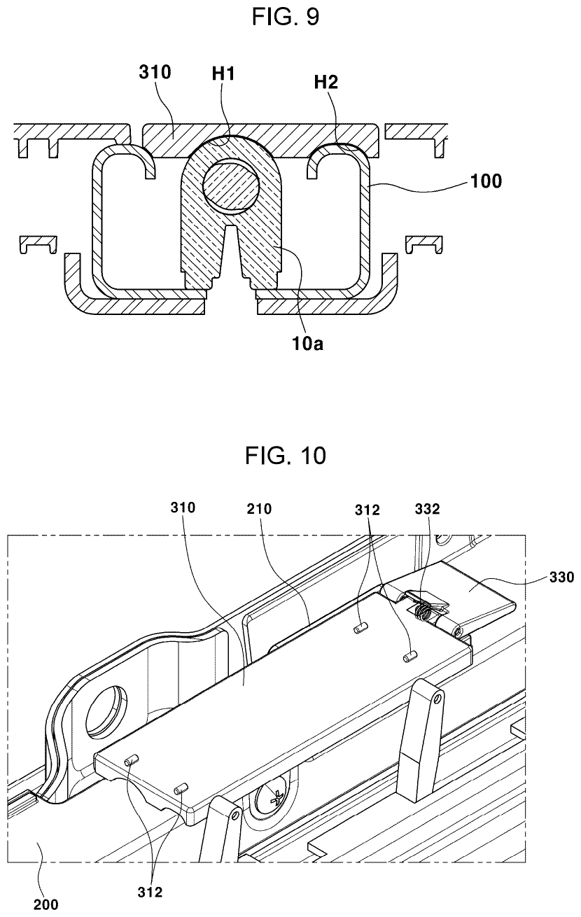

FIG. 8 is a view showing a stopper in the foreign substance blocking device of the vehicle seat rail according to the embodiment of the present disclosure, FIG. 9 is a cross-sectional view of a seating groove in the foreign substance blocking device of the vehicle seat rail according to the embodiment of the present disclosure, taken along line A-A in FIG. 6, and FIG. 10 is a view showing a roller member and a side wall member in the foreign substance blocking device of the vehicle seat rail according to the embodiment of the present disclosure.

As shown in FIG. 1A, when the fixed position of a seat 10 is located at the rearmost position on a forward-and-rearward movement path, and a lead screw 10a coupled to the inside of the lower rail 100 is covered by an upper rail 200 to move the seat 10, the lead screw 10a may not be exposed to the outside.

However, for example, as shown in FIG. 1B, in a tilting walk-in mode, when a seatback 12 is folded forwards to allow a passenger sitting on the third-row seat of a vehicle to comfortably exit the vehicle and then a seat cushion 14 is moved to the foremost position, the lead screw 10a is exposed to the outside from the lower rail 100. In this case, foreign substances may enter the inside of the lower rail 100 and a gap between the lead screw 10a and the lower rail 100, and a shoe heel of the passenger may be caught by the lower rail 100 when the passenger sitting on the third-row seat exits the vehicle.

To address the above-described problems, as shown in FIG. 2, the foreign substance blocking device of the vehicle seat rail according to the present embodiment may include the lower rail 100, the upper rail 200, and a rail cover 300.

The lower rail 100 may extend lengthwise along a floor panel of the vehicle and may be fixedly installed on the floor panel. Further, a plurality of configurations including the lead screw 10a may be provided in the lower rail 100 for forward-and-rearward movement of the seat 10.

In addition, the upper rail 200 is coupled to the lower rail 100 and is mounted on the seat cushion 14. Here, the upper rail 200 is configured to enable the seat cushion 14 to be slidably moved along the lower rail 100. As shown in FIG. 2, the rail cover 300 is disposed to be in contact with the upper surface of the upper rail 200 and is axially coupled to the lower rail 100.

Here, the rail cover 300 is obliquely coupled to the lower rail 100 with a predetermined inclination (refer to FIG. 2). Additionally, as shown in FIG. 3, the rail cover 300 is provided to be rotatably moved in conjunction with sliding movement of the upper rail 200 toward the front side of the lower rail 100 in a state in which the rail cover 300 is in contact with the upper surface of the upper rail 200.

Accordingly, the rail cover 300 is disposed to be in close contact with the upper surface of the lower rail 100 in the tilting walk-in mode and is formed to shield an open inner area A of the lower rail 100. When the tilting walk-in mode is released, that is, in the initial position of the seat 10, the rail cover 300 is disposed to be in contact with the upper surface of the upper rail 200 even if the same is slidably moved in the forward-and-rearward direction by a predetermined range. Accordingly, the upper rail 200 is slidably moved beneath the rail cover 300.

The rail cover 300 has a cover body 310, a connecting link 320, and a sliding movement guide 330, as shown in FIGS. 2 and 3.

The cover body 310 is disposed to be in contact with the upper surface of the upper rail 200 and is formed to extend in the longitudinal direction. Further, as shown in FIG. 6, the cover body 300 is formed to selectively shield the inner area A of the lower rail 100, in which the lead screw 10a is located.

The cover body 310 is preferably formed to have a rectangular shape and is more preferably formed to have a longer widthwise length than a widthwise length of the inner area A.

The cover body 310 is disposed to be in contact with the upper surface of the upper rail 200 and is configured to be rotatably moved in conjunction with sliding movement of the upper rail 200. Here, although one side of the cover body 310 is supported by the connecting link 320, the other side thereof is mounted on the upper surface of the upper rail 200 without any additional support. In this case, the upper rail 200 may have a side wall member 210 provided thereon and configured to guide a rotational movement path of the cover body 310.

That is, as shown in FIG. 10, the side wall member 210 is formed to extend lengthwise to be in contact with the other side of the cover body 310 and is formed upright to guide the rotational movement path of the cover body 310 by sliding movement of the upper rail 200.

Here, the cover body 310 may include a plurality of roller members 312. As shown in FIG. 10, in a state in which the roller members 312 are provided in contact with the upper surface of the upper rail 200, the roller members 312 may be rotatably moved along the upper surface of the upper rail when the upper rail 200 is slidably moved forwards or rearwards. In this manner, sliding movement of the upper rail 200 may be easily performed.

Preferably, a pair of the roller members 312 may be provided on each of the front and rear sides of the cover body 310, and the roller members 312 may be disposed spaced apart from each other in the left and right directions. Such a structural configuration is only one embodiment, and the present disclosure is not limited thereto. The roller member 312 may be selectively provided on either the left or right side of the lower surface of the cover body 310, or a plurality of roller members 312 may be continuously provided on the lower surface of the cover body 310 in the forward-and-rearward direction.

In addition, the cover body 310 may have seating grooves H1 and H2 formed therein. Here, the shape of the seating groove H1 is formed to correspond to the shape of the lead screw 10a mounted in the inner area A, and the shape of the seating groove H2 is formed to correspond to the shape of the lower rail 100, as shown in FIG. 9.

In detail, when the cover body 310 is rotatably moved to shield the inner area A, the cover body 310 needs to be disposed so as to be in close contact with the upper surface of the lower rail 100. To this end, the seating groove H1 corresponding to the shape of the lead screw 10a and the seating groove H2 corresponding to the upper shape of the lower rail 100 are formed to extend in the longitudinal direction of the cover body 310. Accordingly, as shown in FIG. 5, the cover body 310 may be effectively in close contact with the upper surface of the lower rail 100.

The connecting links 320 are rotatably connected to the front side and the rear side of one side of the cover body 310 and are rotatably coupled to the lower rail 100, thereby guiding rotational movement of the cover body 310 in response to sliding movement of the upper rail 200.

Each of the connecting links 320 may be provided with an elastic member 322, as shown in FIG. 7.

The elastic member 322 may be mounted on a rotating shaft to be axially coupled to the lower rail 100 and may provide elastic force to the cover body 310 in a direction in which the inner area A is shielded.

More specifically, the elastic member 322 provides elastic force clockwise to the cover body 310. Accordingly, when the cover body 310 is in close contact with the upper surface of the lower rail 100, the close contact state therebetween may be maintained by elastic force (refer to FIG. 5). In this manner, in the tilting walk-in mode, the inner area A may be stably shielded by the cover body 310.

In addition, the sliding movement guide 330 is rotatably coupled to the front side of the cover body 310 (refer to FIGS. 2 and 3) and is disposed to selectively contact the rear surface of the upper rail 200 when the cover body 310 shields the inner area A in the tilting walk-in mode.

Here, the sliding movement guide 330 may include an elastic member 332.

The elastic member 332 is coupled to a rotating shaft to be axially coupled to the front side of the cover body 310 and is configured to provide elastic force clockwise, that is, in a direction in which the sliding movement guide 330 contacts the rear surface of the upper rail 200, as shown in FIG. 7. Here, when the sliding movement guide 330 is pressed against the rear surface of the upper rail 200, the pressed state may be maintained by the elastic member 332.

In this manner, since the sliding movement guide 330 is disposed to be in contact with the rear surface of the upper rail 200, the upper rail 200 may easily slide between the cover body 310 and the lower rail 100 when the tilting walk-in mode, is released such that the upper rail 200 is slidably moved to the initial position.

Here, in the tilting walk-in mode, the sliding movement guide 330 may form a predetermined inclination angle by supporting the upper rail 200 having an inclined rear surface and may be disposed to contact the upper rail 200. The inclination angle may be maintained by a stopper 334 provided on the sliding movement guide 330.

That is, as shown in FIG. 8, the stopper 334 may be mounted in a connection area of the cover body 310 such that the inclination angle is maintained when the upper rail 200 is slidably moved due to release of the tilting walk-in mode. Through such a structural configuration, even if the sliding movement guide 330 is pressed by the upper rail 200, rotation of the sliding movement guide 330 is restricted in a direction facing the upper surface of the cover body 310. Accordingly, when the tilting walk-in mode is released, the upper rail 200 may be slidably moved along the sliding movement guide 330 having the predetermined inclination angle and may be slidably moved between the cover body 310 and the lower rail 100.

Based on the configuration of the foreign substance blocking device of the seat rail according to the above-described embodiment, transition to the tilting walk-in mode will be described below with reference to FIGS. 4A to 4C.

First, when the tilting walk-in mode is performed, as shown in FIG. 4A, the upper rail 200 is slidably moved between the cover body 310 and the lower rail 100, and thus the cover body 310 is also rotated forwards by sliding movement of the lower rail 200.

As shown in FIG. 4B, when the upper rail 200 is slidably moved toward the foremost position of the lower rail 100 according to the tilting walk-in mode, the sliding movement guide 330 forms a predetermined inclination angle by the upper rail 200 and is rotated around the cover body 310. In this case, the sliding movement guide 330 supports the inclined rear surface of the upper rail 200 by elastic force provided by the elastic member 332. Then, as shown in FIG. 4C, when the upper rail 200 continuously slides toward the foremost position, the sliding movement guide 330 constantly supports the inclined rear surface of the upper rail 200.

Finally, when the upper rail 200 is moved to the foremost position of the lower rail 100 in the tilting walk-in mode, the cover body 310 comes into close contact with the upper surface of the lower rail 100, as shown in FIGS. 5 and 6. As a result, the cover body 310 shields the inner area A of the lower rail 100. In this manner, it is possible to prevent foreign substances such as dust from being introduced into the inner area A or to prevent a shoe heel of a passenger from falling into the inner area A, thereby securing quality and stability of the seat 10.

According to the present disclosure, an upper rail is slidably moved along a lower area of a cover by the cover disposed upright on a lower rail, and when the upper rail is slidably moved to the foremost position of the lower rail according to a tilting walk-in operation, the cover is selectively rotated to come into close contact with the lower rail. In this manner, an open upper surface of the lower rail may be shielded by the cover, thereby having an effect of preventing foreign substances from entering the interior of the lower rail.

Therefore, according to the present disclosure, it is possible not only to secure operation performance of the upper rail by blocking inflow of foreign substances, but also to secure quality and stability of a vehicle seat by preventing a shoe heel of a passenger from falling into or getting caught by the lower rail.

As is apparent from the above description, the present disclosure provides a foreign substance blocking device of a vehicle seat rail, configured in such a manner that an upper rail is slidably moved along a lower area of a cover by the cover disposed upright on a lower rail, and when the upper rail is slidably moved to the foremost position of the lower rail according to a tilting walk-in operation, the cover is selectively rotated to come into close contact with the lower rail. In this manner, the foreign substance blocking device has an effect of shielding an open upper surface of the lower rail using the cover and preventing foreign substances from entering the interior of the lower rail.

Therefore, according to the present disclosure, it is possible not only to secure operation performance of the upper rail by blocking inflow of foreign substances, but also to secure quality and stability of a vehicle seat by preventing a shoe heel of a passenger from falling into or getting caught by the lower rail.

The present disclosure has been described in detail with reference to preferred embodiments shown in the drawings, but the embodiments are merely illustrative. It will be appreciated by those skilled in the art that various modifications may be made from the embodiments, and all or a part of the embodiments may be selectively combined with each other. Therefore, the true technical protection scope of the present disclosure should be defined by the technical spirit of the appended claims.

What is claimed is:

1. A foreign substance blocking device for a vehicle seat rail, the foreign substance blocking device comprising:
a lower rail configured to extend lengthwise along a floor panel of a vehicle, the lower rail configured to be fixedly installed on the floor panel, the lower rail including an open inner area;
an upper rail coupled to the lower rail and configured to be mounted on a seat cushion, the upper rail configured to enable the seat cushion to be slidably movable along the lower rail, the upper rail being slidably movable toward a foremost position in a tiling walk-in mode; and
a rail cover coupled to the lower rail and disposed to be in contact with an upper surface of the upper rail, the rail cover configured to be rotatably moved in conjunction with sliding movement of the upper rail toward the foremost position in the tiling walk-in mode such that the open inner area of the lower rail is shielded by the rail cover.

2. The foreign substance blocking device of claim 1, wherein:
the rail cover is disposed to be in close contact with an upper surface of the lower rail in the tilting walk-in mode, and
the rail cover is disposed to be in contact with the upper surface of the upper rail based with the tilting walk-in mode being released.

3. The foreign substance blocking device of claim 1, wherein the rail cover includes:
a cover body disposed to contact the upper surface of the upper rail, the cover body configured to extend lengthwise to selectively shield the open inner area;
connecting links rotatably connected to front and rear sides of one side of the cover body and rotatably coupled to the lower rail, the connecting links configured to guide rotational movement of the cover body; and
a sliding movement guide coupled to a front side of the cover body, the sliding movement guide disposed to contact a rear surface of the upper rail based on the cover body selectively shielding the open inner area.

4. The foreign substance blocking device of claim 3, wherein the cover body includes a roller member mounted on a lower surface thereof, and wherein the sliding movement of the upper rail is configured to be performed by the roller member being in contact with the upper surface of the upper rail.

5. The foreign substance blocking device of claim 3, wherein the upper rail includes a side wall member formed upright and to extend lengthwise to contact the other side of the cover body, the side wall member configured to guide a rotational movement path of the cover body.

6. The foreign substance blocking device of claim 3, wherein the cover body includes seating grooves formed thereon, and wherein the seating grooves have shapes respectively corresponding to a shape of the lower rail and a shape of a lead screw mounted in the open inner area.

7. The foreign substance blocking device of claim 3, wherein the connecting link includes an elastic member, the elastic member configured to provide elastic force to the cover body in a direction in which the open inner area is shielded by the cover body.

8. The foreign substance blocking device of claim 3, wherein the sliding movement guide includes an elastic member, the elastic member configured to provide elastic force in a direction in which the sliding movement guide contacts of the upper rail.

9. The foreign substance blocking device of claim 3, wherein the sliding movement guide is configured to form an inclination angle relative to the rear surface of the upper rail in the tilting walk-in mode.

10. The foreign substance blocking device of claim 9, wherein the sliding movement guide includes a stopper mounted in a connection area of the cover body, the stopper configured to maintain the inclination angle based on the upper rail being slidably moved due to release of the tiling walk-in mode.
